(19) United States
(12) Patent Application Publication
(10) Pub. No.: US 2008/0130473 A1
(43) Pub. Date: Jun. 5, 2008

(54) VIDEO CAMERA WITH DISK DEVICE AND CONTROL METHOD THEREOF

(76) Inventor: Tatsuya Ishitobi, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/947,823

(22) Filed: Nov. 30, 2007

(30) Foreign Application Priority Data
Nov. 30, 2006 (JP) 2006-322770

(51) Int. Cl. G11B 17/028

(52) U.S. Cl. 369/267

(57) ABSTRACT

A video camera with a disk drive capable of recording and reproducing operations with stability and silence achieved by suppressing vibration and noise caused by disk rotation. The number of revolutions of the disk is controlled according to states of the video camera. The disk drive comprises a disk rotation control unit for rotating the disk at an optional number of revolutions under rotation control and an adjusting process unit for recording data on the disk, in which one or both of the disk rotation speed and the rotation control method are changed by using an adjusting process executed in a period when recording is performed and the adjusting process executed in a period when recording is not performed.

### INCORPORATION BY REFERENCE

The present application claims priority from Japanese application JP2006-322770 filed on Nov. 30, 2006, the content of which is hereby incorporated by reference into this application.

### BACKGROUND OF THE INVENTION

The present invention relates to technology related to control in a video camera with a disk drive.

In a disk drive, vibration and noise are generated by the rotation of the disk. The vibration and noise are a serious problem particularly with video cameras in which the absence of noise, or silence, is required. The following patent literature discloses examples of a method for avoiding the problem of vibration caused by the rotation of the disk in the disk drive.

JP-A-10-92090 describes, with regard to means for solving the problem in paragraph [0015], that “a first rotational speed is changed to a second rotational speed when a disk distinguishing part determines, in a state in which a disk-shaped recording medium is rotating at the first rotational speed, whether the disk-shaped recording medium is an eccentric disk or an unbalanced disk.”

Furthermore, JP-A-2001-60357 (corresponding to U.S. Pat. No. 6,195,322) describes, with regard to means for solving the problem in paragraph [0004], that “the disk operation is controlled so that the disk does not rotate at a predetermined rotational speed, at which vibration characteristic of the disk is generated, to thereby prevent the disk from vibrating and enable a recording or reproducing operation in a stable manner.”

### SUMMARY OF THE INVENTION

The video camera is a device which is directly held by a hand when it is used. With a video camera equipped with a disk drive, even if vibration generated by the rotation of the disk is occurring to such an extent that it is not detrimental to recording or reproducing data to or from the disk, the vibration may sometimes be a problem when it is assessed by how much it is transmitted to the hand. The vibration and noise caused by the rotation of the disk can be reduced effectively by reducing the number of rotations of the disk.

However, when the number of rotations of the disk is reduced, the playback speed and the recording speed of data from and to the disk are decreased. This speed decrease becomes a problem with a video camera that needs to store recorded images in real time. Therefore, necessary measures must be taken to enable real-time operations in recording and reproduction.

As the number of revolutions of the disk is decreased, more time is spent and more electric power is consumed when recording the same amount of information. Since the video cameras normally operate with battery, some attempts need to be made to reduce power consumption so that time available for video recording does not become short.

The sound generated by the rotation of the disk becomes a problem when the sound is picked up by the microphone of the video camera and recorded as noise on the disk. The noise can be reduced basically by decreasing the number of revolutions of the disk, but when the number of revolutions of the disk is changed by movement of the pick-up unit, noise occurs temporarily caused by changes in the disk rotational speed, a fact which should be given due consideration.

The present invention has as its object to provide a video camera with a disk drive capable of recording and reproducing operations with stability and silence achieved by suppressing vibration and noise caused by disk rotation.

The aforementioned problems can be solved by the invention described in the claims.

Thus, a video camera can be provided which secures stable recording and reproduction operations with reduced vibration and noise attendant on the rotation of the disk.

The other objects and methods of achieving the objects will be readily understood in conjunction with the description of an embodiment of the present invention and the drawings.

### BRIEF DESCRIPTION OF THE DRAWINGS

FIG. 1 is a block diagram showing a video camera carrying a disk drive according to the present invention.

FIG. 2 is a graph depicting a relation between number of disk revolutions and data transfer rate when a BD-RE disk is played at double speed.

FIG. 3 is a graph illustrating a relation between number of disk revolutions and data transfer rate when a BD-RE disk is played at double speed under disk rotation control according to the present invention.

FIG. 4 is a graph showing laser power for recording at various radial positions of the disk in disk rotation control according to the present invention.

### DETAILED DESCRIPTION OF THE EMBODIMENTS

The main points of the present invention will be mentioned and then preferred embodiments of the present invention will be described. The main points of the present invention are as follows.

The present invention solves all of the above-mentioned problems, and therefore can suppress the occurrence of vibration and noise caused by the rotation of the disk. To achieve this solution, the present invention controls the rotation of the disk so as to meet the following conditions.

(1) A number of revolutions of the disk is set to realize stable operations of recording and reproducing data to and from the disk and also to lessen the vibration transmitted to the hand holding a video camera to a permissible level.

(2) A number of revolutions of the disk is set so as to enable real-time motions in a video camera.

(3) This number of revolutions of the disk should be such as to reduce power consumption in the disk drive and lessen noise caused by the rotation of the disk.

(4) If the disk is to be rotated at a number of revolutions that generates vibration that exceeds a permissible value, for which purpose, a recording-prohibited period in the video camera should be utilized.

In the following, description will be made of an example in which a disk drive suitable for a video camera is provided. In this example, it is based on the assumption that a Blu-ray disk BD-RE (Blu-ray Disk Rewritable) is used as a recording medium and that video information at a data bit rate of about 25 Mbps (25,000,000 bits/s) is recorded on this disk. Incidentally, video cameras which use a DVD disk as a recording medium are sold by various manufacturers, but it has not been confirmed at this moment whether or not any video camera using a blue-ray disk as a recording medium has been released on the market.

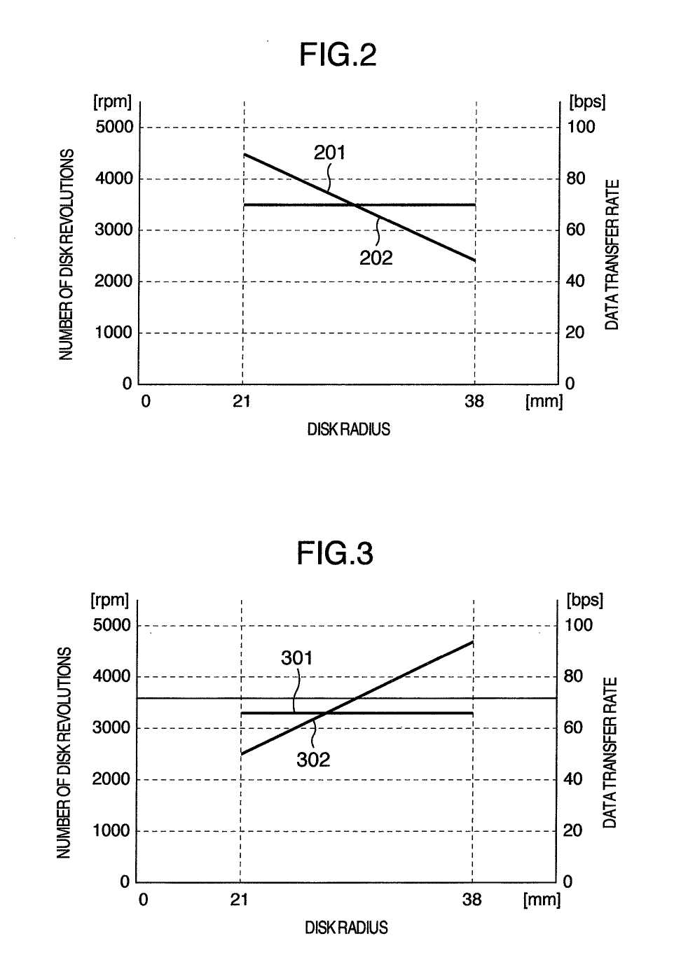

Currently, a BD-RE disk can record data at double speed at a linear velocity of 9834 mm/s, and a data transfer rate at this linear velocity is about 72 Mbps (72,000,000 bits/s). If a disk is rotated under linear constant velocity CLV (Constant Linear Velocity) control, the number of revolutions at a radial position of 21 mm corresponding to the leading end of an information area on a 80 mm-diameter single layer disk is about 4472 rpm (revolutions/min) and the number of revolutions at a radial position of 38 mm corresponding to the trailing end of the data area is about 2471 rpm as shown in FIG. 2. FIG. 2 is a graph in which the horizontal axis indicates the disk radius [mm], the left vertical axis indicates the number of disk revolutions [rpm], and the right vertical axis indicates the data transfer rate [bps]. A straight line 201 denotes the number of revolutions and a straight line 202 denotes the data transfer rate.

Video cameras that use DVD-RAM recoding media have currently been on the market, and on a DVD-RAM disk, the number of revolutions at a radius of 21 mm is about 3240 rpm. From experience this number of revolutions is considered to be a value closest to an allowable limit. It has been known that a number of revolutions at double speed at a radius of 21 mm at the inner circumference of a BD-RE disk is 38 percent higher than the number of revolutions of the DVD-RAM disk. Since vibration caused by the disk rotation is proportional to a number of revolutions squared, it can be easily estimated that the vibration that occurs at this number of revolutions is not permissible for video cameras.

As a solution for this problem, disk rotation control according to the present invention is applied. First of all, to meet the condition (1) of the present invention, 3240 rpm, equivalent to the speed of a DVD-RAM disk drive, is set as the number of revolutions at a radius of 21 mm on a disk, at which radius the number of revolutions of a disk under CLV control is highest. Under CLV control, the number of revolutions becomes slower as the pick-up unit moves toward the outer circumference of the disk; therefore, the number of revolutions at a radius of 38 mm at the outermost circumference is 1791 rpm and the vibration occurring caused by the rotation of the disk over the whole area of the disk can be reduced to a level that poses no problem to video cameras.

In addition, the linear speed over the whole area of the disk becomes about 7125 mm/s and the data transfer rate becomes about 52 Mbps. This data transfer rate is lower than the maximum recording data transfer rate of existing BD-RE disks but this data rate is sufficiently higher than the video information transfer rate of 25 Mbps, making it possible to adequately realize real-time motions in video cameras. Thus, the condition (2) of the present invention is satisfied.

Then, the condition (3) of the present invention will be met as follows. With a video camera, the data bit rate of video information is 25 Mbps, but because the data transfer rate of the disk drive is basically higher than the data bit rate, it follows that the disk drive performs intermittent recording during video recording. Therefore, the higher the data transfer rate of a disk drive, the shorter the actual time period of recording and the lower the power consumption that can be reduced. To realize this, it is necessary to apply CAV (Constant Angular Velocity) that maintains a number of revolutions of 3240 rpm, at which vibration caused by disk rotation causes trouble, over the whole area of the disk.

The CAV control can be depicted as shown in FIG. 3. FIG. 3 is a graph, in which the horizontal axis indicates the disk radius [mm], the left vertical axis indicates the number of disk revolutions [rpm], and the right vertical axis indicates the data transfer rate [bps]. A straight line 301 denotes the number of revolutions, and a straight line 302 denotes the data transfer rate. The linear speed at a radius of 21 mm is 7125 mm/s and the data transfer rate is 52 Mbps, and since the data transfer rate increases as the pick-up unit moves towards the outer circumference of the disk, the linear speed at a radius of 38 mm is 12893 mm/s and the data transfer rate is about 94 Mbps. In other words, because actual recording time period in intermittent recording becomes shorter as the pick-up unit moves towards the outer circumference of the disk, power consumption can be reduced.

Since the decrease in power consumption can suppress temperature rise in the video camera, the disk drive can be made to operate under suitable temperature. Moreover, by implementing CAV control, it becomes unnecessary to adjust the number of revolutions of the disk each time the pick-up unit is moved, making it possible to suppress occurrence of noise caused by changes in the number of revolutions of the disk.

If a method for disk rotation control in the disk drive is decided in the manner described, the disk drive can be made basically suitable for a video camera. However, in view of recording data to a BD-RE disk, which was described above as an example, special attention needs to be given.

In recording to a disk, it is necessary to determine optimum laser power for recording. This optimum Laser power is determined by an adjusting process called OPC (Optimum Power Control). This process includes recording operations in the OPC area on the disk while varying recording power in steps and identifying the optimum power at which recording could be done appropriately. Since laser power suitable for recording differs with the linear speed, it is necessary to perform OPC for different linear speeds.

In CAV control in which the linear speed varies on the whole area of the disk, it takes much time and effort to execute OPC for all linear speeds. By executing OPC at least at two different linear speeds, a relation between linear speeds and laser power is grasped, by which the laser power at other linear speeds can be obtained without executing the OPC process.

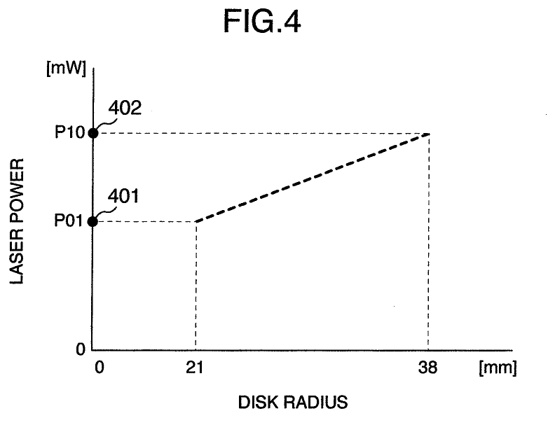

As for linear speeds at which OPC is executed, if at least two linear speeds are known,in other words, if a minimum linear speed or a linear speed close to the minimum linear speed, and a maximum linear speed or a linear speed close to the maximum linear speed are known, a whole range of linear speeds exists between those two linear speeds, and any specific linear speed can be obtained easily and therefore laser power can be controlled stably. An example is shown in FIG. 4. FIG. 4 is a graph, in which the horizontal axis indicates the radius of the disk [mm], and the vertical axis indicates laser power necessary for recording [mW].

In FIG. 4, 401 denotes laser power P01 obtained by OPC executed at a minimum linear speed, and 402 denotes laser power P10 obtained by OPC executed at a maximum linear speed. It can be easily presumed that laser power at intermediate linear speeds exists between the laser power P01 and the laser power P10. Therefore, laser power Pr necessary at a radius of r [mm] can be calculated, for example, by an equation as follows.

Pr=P01+(R−21)×(P10−P01)/(38−21) (Equation)

On the BD-RE disk described taken up for example, there is an OPC area in the vicinity of a radius of 23.5 mm at the inner circumferential region of the disk where the linear speed lowest under CAV control, but the OPC area does not exist at the outer circumferential region of the disk where the linear speed is highest. Therefore, when executing the OPC process, it is necessary to arrange so that a maximum linear speed or a linear speed close to the maximum linear speed in the OPC area in the vicinity of a radius of 23.5 mm. In order to obtain a high linear speed at the inner circumferential region of the disk, it is necessary to raise the number of revolutions of the disk.

At a position located at a radius of 23.5 mm, to obtain a linear speed of 12893 mm/s at a radius of 38 mm where the linear speed rises highest under CAV control at a number of revolutions of 3240 rpm, the number of revolutions must be raised to not less than 5200 rpm. Though OPC takes about 5 sec at most, because the number of revolutions of the disk shoots up to a value well over a permissible value while recording with a video camera, it is not permitted to raise the number of revolutions to 5200 rpm during recording from a viewpoint of vibration and noise.

To solve this problem, some measures are taken to meet the condition (4) of the present invention. To be more specific, with a video camera, OPC is performed in time periods when video recording operations are not permitted. This time period is, for example, a period when a format process is performed on a disk. When a disk is loaded into the video camera, the disk is formatted by the format process. The format process records various kinds of information on the disk to enable the video camera to record video information on the disk.

After the above process has been executed, it becomes possible to record video information on the disk, and the video camera is put in a state in which a video recording operation is permitted. While during this format process, even when OPC is performed at the maximum linear speed in the inner circumferential region of the disk, vibration and noise are generated temporarily by the rotation of the disk, since this process takes place in a period when a video recording operation is not permitted, there is no adverse affect on the recording.

To cite other examples, the periods for executing the OPC process may be the start-up process period, such as just after a disk is loaded into the video camera, or after a disk has been loaded and just after power is supplied to the video camera. In the start-up process, a process, such as disk identification is performed, and it is determined whether or not the disk is in a usable condition. After it has been determined that the disk is in a usable condition, the video camera is permitted to proceed with a recording operation. Therefore, even if the OPC process is executed in this start-up period and vibration occurs owing to high-speed rotation of the disk, because this is a recording prohibited period and recording is not performed, there is no adverse affect on recording.

As described above, in the video camera, the number of revolutions of the disk is controlled according to the operation mode, whether the camera is in a recording permitted state or in a recording prohibited state, so that the number of revolutions of the disk in the recording permitted state does not exceed the number of revolutions of the disk in the recording prohibited state. Therefore, vibration and noise are reduced during recording and video recording can be performed under good conditions.

During a period when recording is not performed, an adjusting process, such as OPC, which requires high-speed rotation can be executed, and preparations for video recording, such as determination of laser power for recording, can be completed.

The OPC process may need to be performed again in such a case where a temperature change occurred, for example. Should this happen during recording, OPC has to be carried out. However, in OPC, it is not permissible to generate vibration and noise that have adverse effects on video recording. In consideration of this problem, too, the present invention proposes to perform the OPC process at linear speeds obtainable only at a normal number of disk revolutions in the OPC area in the inner circumferential region of the disk during recording.

Before this OPC process (with recording) is executed, there are prerequisites that an OPC process (without recording) has been carried out at least at a minimum linear speed or a linear speed close to the minimum linear speed and a maximum linear speed or a linear speed close to the maximum linear speed by using a period when a recording operation is not permitted in the video camera, and that laser power at the two linear speeds determined in the above-mentioned OPC process has been obtained. The laser power at the two linear speeds obtained previously in the OPC process may be recorded in a nonvolatile memory or in an area of the disk, which is intended for storing information peculiar to the disk drive, and may be retrieved later for use.

For example, the laser power at the minimum linear speed is designated as P01 and the laser power at the maximum linear speed is designated as P10; as is obvious, these minimum and maximum linear speeds were used previously. When OPC is executed anew, laser power at the minimum linear speed obtained in this OPC process is designated as P02. Though OPC is not executed by finding and using a maximum linear speed, laser power P20 at a new maximum linear speed based on the laser power P01, P10 and P02 is calculated by using the following equation, for example.

P20=P10×P02/P01 (Equation)

By doing as described, OPC can be executed with the normal number of disk revolutions maintained during vide recording, vibration and noise by the rotation of the disk can be prevented, thus eliminating chances of adverse effects on recording.

As described above, according to the present invention, recording and reproduction of data in the disk drive is performed stably, and the occurrence of vibration and noise caused by disk rotation is reduced, the improvement of which can be achieved with low power consumption. In the foregoing description, as the disk rotation method, an example in which CAV control was applied is shown, but the disk rotation method is not limited to the CAV control.

An embodiment of the present invention will be described as follows.

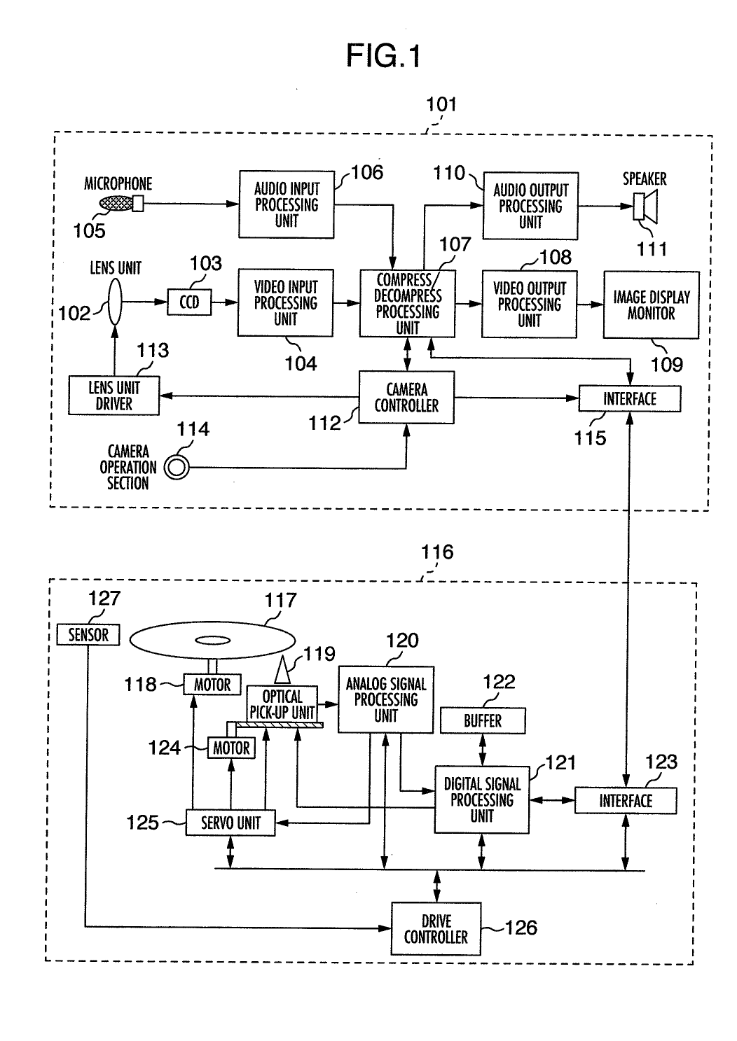

FIG. 1 is a block diagram of a video camera carrying an optical disk drive according to an embodiment of the present invention. In FIG. 1, a block 101 encircled by a broken line is an imaging device and a block 116 encircled by a broken line is a disk drive.

In FIG. 1, the imaging device 101 includes a lens unit 102, an image sensor 103 (CCD, for example), a video input processing unit 104, a microphone 105, an audio input processing unit 106, a compress/decompress processing unit 107, a video output processing unit 108, an image display monitor 109, an audio output processing unit 110, a speaker 111, a camera controller 112, a lens unit driver 113, a camera operation section 114, and a disk drive interface 115.

In FIG. 1, the disk drive 116 includes a disk (removable from the disk drive 116), a spindle motor 118, an optical pick-up unit 119, an analog signal processing unit 120, a digital signal processing unit 121, a buffer memory 122, a camera interface 123, a course motor 124, a servo unit 125, a drive controller 126 as an adjusting process unit to record data on the disk, and a disk cover open/close sensor 127 (the disk cover is not shown).

As described above, to record information onto the disk, it is necessary to have laser power necessary for recording determined previously. Since this laser power is determined by OPC, OPC will proceed as follows. Meanwhile, the disk 117 is a DB-RE disk with a diameter of 80 mm, the data bit rate of video information is 25 Mbps at a maximum, and the normal number of revolutions is constant at 3240 rpm over the whole area of the disk. The following description will omit those motions which are not required in the present invention.

When a disk is loaded in the video camera and the disk cover is closed, the disk drive detects the loading of a disk via, with its drive controller 126 through the disk cover open/close sensor 127. The drive controller 126 sends commands to the servo unit 125 to cause the spindle motor 118 to rotate and also cause the servo unit 125 to emit laser beams based on reproduction power from the optical pick-up 119. Note that at this time the disk rotates at 3240 rpm under CAV control.

When laser beams are emitted to the disk, the pick-up unit 119 converts reflected beams into an electric signal, and the electric signal is sent to the analog signal processing unit 120, which generates an error signal necessary for servo control, such as focusing and tracking. When the error signal generated in the analog signal processing unit 120 is sent to the servo unit 125, it becomes possible to implement servo control, such as focusing and tracking, in the servo unit 125.

When it becomes possible to perform servo control in the servo unit 125, the drive controller 126 sends a command to the servo unit 125 to move the optical pick-up unit to the inner circumferential region where there is the OPC area to execute the OPC process.

Responding to the command, the servo unit 125 drives the course motor 124 to move the optical disk 119 into the inner circumferential region of the disk. Then, the drive controller 126 receives address information on the disk 117 through the pick-up unit 119, the analog signal processing unit 120, and the digital signal processing unit 121, checks whether the optical pick-up unit 119 has moved to in front of the OPC area, and if the pick-up unit has not reached, the drive controller 126 repeatedly supplies the servo unit 125 with a command to move the optical pick-up unit 119 until it reaches the front of the OPC area.

When the optical pick-up unit 119 comes in front of the OPC area, the drive controller 126 supplies the digital signal processing unit 121 with a command to record data at addresses in the OPC area while varying laser power in steps.

In response to this command, the digital signal processing unit 121 obtains an address on the disk from an address signal received through the optical pick-up unit 119 and the analog signal processing unit, and on detecting an address specified by the drive controller 126, the digital signal processing unit 121 performs recording while varying the laser power in steps.

When recording in the OPC area has been completed, the drive controller 126 again supplies the servo unit 125 with a command to move the optical pick-up unit 119 to in front of the OPC area, and when the movement of the optical pick-up unit 119 has been completed, the drive controller 126 issues a command to the digital processing unit asking it to reproduce the OPC area where recording has was performed.

In response to this command, the digital signal processing unit 121 obtains an address on the disk from the address signal received through the optical pick-up unit 119 and the analog signal processing unit 120, and on detecting an address specified by the drive controller 126, the digital signal processing unit 121 reproduces the OPC area, and stores information obtained on this occasion from the disk 117 into the buffer memory 122.

When reproduction in the OPC area is completed, the drive controller 126 obtains reproduction information obtained in the buffer memory 122 through the digital signal processing unit 121, and determines laser power suitable for recording based on the reproduction information. Thus, the laser power for recording at a minimum linear speed is established.

Then, to execute the OPC process at a maximum linear speed, the drive controller 126 supplies the servo unit 125 with a command to rotate the spindle motor 118 at 5239 rpm. In the same manner as described, the drive controller 126 executes the OPC process in the OPC area in the inner circumferential region. Therefore, the laser power for recording at a maximum linear speed is determined.

As for a rotation control method at a higher number of revolutions of the spindle motor 118, CAV control is performed, but CLV control may be used. Before the number of revolutions of the spindle motor 118 is increased to execute the OPC process at a maximum linear speed, if laser power for recording at at least two, minimum and maximum linear speeds acquired in the past OPC process by reproducing data from the storage areas of drive-specific information, laser power for recording at a maximum linear speed may be calculated by the aforementioned calculation without executing the OPC process at the maximum linear speed.

Since laser power for recording at at least two, minimum and maximum linear speeds can be obtained as described above, the disk drive 116 place in a state ready to record information to the disk 117. The values of laser power for recording at the two, minimum and maximum linear speeds obtained by the OPC process are stored by the drive controller 126 into its own nonvolatile memory. Furthermore, if the drive controller 126 orders the digital signal processing unit 121 to record the same laser power values in a drive-specific information storage area on the disk, afterwards even in a case where the OPC process is executed only at the minimum linear speed, it becomes possible to calculate laser power for recording at a maximum linear speed by calculation described earlier.

After this, the drive controller 126 supplies the servo unit 125 with a command to again rotate the spindle motor 118 at 3240 rpm, which is a normal number of revolutions. From this time on, since the disk 117 rotates at a normal speed of 3240 rpm, vibration and noise caused by the rotation of the disk do not become a problem.

While the start-up process is progressing in the disk drive 116, the imaging device 101 repeatedly makes an inquiry to see if the start-up process has been completed. Upon completion of the OPC process, the drive controller 126 notifies the imaging device 101 of the completion of the start-up process through the camera interface 123. On receiving notice of the completion of the start-up process from the disk drive 116, the imaging device 101 reads information from the disk 117 through the disk drive 116 and when the imaging device 101 decides that the disk is usable, the video camera is placed in a state capable of video recording.

Subsequently, when a user starts video recording by operating the camera operation section 114, the following motions take place.

Upon being notified of the start of video recording by the camera operation section 114, the camera controller 112, the camera controller 112 starts capturing images through the lens unit 102 which is driven by the lens unit driver 113. Captured images are converted by the image sensor 103 into an electric signal, and then converted by the video input processing unit 104 into a video signal.

The microphone 105 captures sound, and captured sound is converted by the audio input processing unit 106 into an audio signal. A video signal generated by the video input processing unit 104 and an audio signal generated by the audio input processing are compressed by the compress/decompress processing unit 107 and compressed record information is temporarily stored in the compress/decompress processing unit 107.

The camera controller 112 monitors the amount of record information stored in the compress/decompress processing unit 107, and when a first predetermined amount is reached at which data transfer to the disk drive should be started, supplies the disk drive 116, through the disk drive interface 115, with a record request command and an address as location information to record information, and then the camera controller 112 controls the compress/decompress processing unit 107 to send stored record information to the disk drive 116 through the disk drive interface 115.

While record data is being transmitted to the disk drive 116, in the imaging device 101, a series of processes takes place continuously, which includes image capturing, signal conversion, signal compression, and record information accumulation, and when data stored in the compress/decompress processing unit 107 decreases below a second predetermined amount at which data transfer to the disk drive should be stopped, the camera controller 112 supplies the compress/decompress processing unit 107 with a command to stop data transfer to the disk drive 116.

In the disk drive 116, the drive controller 126 receives a command sent from the imaging device 101 through the camera interface 123, and decides that the command is a request to record information, controls the digital signal processing unit 121 to receive record information. The record information received by the digital signal processing unit 121 is stored temporarily in the buffer memory 122, and the amount of stored information is monitored by the drive controller 126.

When the specified amount of information is reached, the drive controller 126 issues a command to control the servo unit 125 to move the optical pick-up unit 119 to in front of an address specified by the imaging device 101. In compliance with the command, the servo unit 125 drives the course motor 124 to move the optical pick-up unit 119 to a location specified by the disk controller 126, and also controls the spindle motor 118 to rotate at a predetermined number of revolutions.

At this time, laser beams of a reproduction level are emitted to the disk 117 from the optical pick-up unit 119, reflected beams from the disk 117 are converted by the optical pick-up unit 119 into an electric signal, which is sent to the analog signal processing unit 120. The analog signal processing unit 120 generates an error signal necessary for servo control, such as focusing and tracking, which is sent to the servo unit 125 and also generates an address signal to specify an address location on the disk, and sends the address signal to the digital signal processing unit 121.

Subsequently, the drive controller 126 issues a command to the digital signal processing unit 121 to write record information at an address on the disk, which is specified by the imaging device 101. In response to the command, the digital signal processing unit 121 adds an error-correction code to the record information stored in the buffer memory 122, modulates the record information, and on detecting an address specified by the drive controller 126 based on an address signal supplied through the optical pick-up unit 119 and the analog signal processing unit 120, the drive controller 126 sends modulated record information to the optical pick-up unit 119.

Thus, laser beams in emission light pattern based on modulated information are emitted onto the disk 117 by the optical pick-up unit 119. Thus, information is recorded on the disk. During a recording operation, the drive controller 126 monitors addresses on the disk, and laser power for recording according to linear speeds at individual addresses, in other words, at linear speeds at different radii, is determined based on laser power at two, minimum and maximum linear speeds obtained by the OPC process executed in the start-up process of the disk drive 116, and laser power for recording may be adjusted as occasion demands. Therefore, information can be recorded with adequate laser power.

After having recorded all of the information which disk drive 116 was requested to record by the imaging device 101, the disk drive 116 does not actually record anything until it again receives a request to record. In this manner, the disk drive 116 records information intermittently during video recording. As a result, as the pick-up unit moves towards the outer circumference of the disk, the linear speed of recording increases and the margin also increases on the disk side in comparison with a maximum data bit rate of 25 Mbps of video information on the imaging device side. Thus, the actual recording period in intermittent recording is shortened, and the utilization rate of the disk drive 116 can be decreased to a low level, so that power consumption can be reduced. Since the disk 117 is rotated under CAV control, the number of revolutions of the disk 117 remains unchanged when the optical pick-up unit 119 is moved, and therefore noise caused by the rotation of the disk can be reduced.

In the foregoing embodiment, the linear speed was changed and OPC was executed during the start-up process, but even in a period when the video recording operation is not permitted in the video camera, for example, in the format process period, the procedure of the OPC process is performed in the same manner. Further, in the above embodiment, a case was described in which by using laser power for recording at at least two different linear speeds obtained by executing the past OP process, OPC was executed only at a linear speed obtained at a normal number of revolutions. If this case is applied during video recording, even if OPC is executed during recording, vibration and noise are not generated.

As has been described, according to the present invention, it is possible to provide a video camera carrying a disk drive capable of recording and reproduction with stability and silence. Needless to say, the values, such as the numbers of revolutions of the disk used in the foregoing description were shown as examples, and were not intended to show the limitations in the manner of embodiment.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

1. A video camera with a disk device, comprising:
a disk rotation control unit which rotates a disk at an optional number of revolutions under rotation control; and
an adjusting process unit for recording data on a disk, wherein the number of revolutions of the disk or a rotation control method is changed or the number of revolutions of the disk and the rotation control method are changed in the adjusting process in a period when video recording is performed or in a period when video recording is not performed.

2. The video camera according to claim 1, wherein the rotation of the disk is controlled so that the number of revolutions of the disk in an adjusting process in a period when video recording is performed does not exceed the number of revolutions of the disk in the adjusting process in a period when video recording is not performed.

3. The video camera according to claim 1, wherein processing time of the adjusting process in the period when video recording is performed is shorter than the processing time of the adjusting process in the period when video recording is not performed.

4. A method for controlling a video camera with a disk device, comprising:
a disk rotation control process which rotates a disk at an optional number of revolutions under rotation control; and
an adjusting process for recording data on a disk, wherein the number of revolutions of the disk or a rotation control method is changed or the number of revolutions of the disk and the rotation control method are changed in the adjusting process in a period when video recording is performed or in a period when video recording is not performed.

5. The method according to claim 4, wherein the rotation of the disk is controlled so that the number of revolutions of the disk in an adjusting process in a period when video recording is performed does not exceed the number of revolutions of the disk in the adjusting process in a period when video recording is not performed.

6. The video camera according to claim 2, wherein processing time of the adjusting process in the period when video recording is performed is shorter than the processing time of the adjusting process in the period when video recording is not performed.
